(19) United States
(12) Patent Application Publication
(10) Pub. No.: US 2009/0153956 A1
(43) Pub. Date: Jun. 18, 2009

(54) MICROSCOPE ILLUMINATION APPARATUS

(75) Inventor: Kenichi Kusaka, Tokyo (JP)

Correspondence Address: FRISHAUF, HOLTZ, GOODMAN & CHICK, P.C., 16th Floor, 220 Fifth Avenue, New York, NY, 10017-2023, US

(73) Assignee: Olympus Corporation, Tokyo (JP)

(21) Appl. No.: 12/336,698

(22) Filed: Dec. 17, 2008

(30) Foreign Application Priority Data
Dec. 18, 2007 (JP) 2007-326009

(51) Int. Cl. G02B 21/06

(52) U.S. Cl. 359/385; 359/656

(57) ABSTRACT

A microscope illumination apparatus includes a light source, a collector lens for converting a light ray from the light source into an almost collimated light flux, a field stop provided in the almost collimated light flux from the collector lens, a field lens for converting a light ray from the field stop into an almost collimated light flux, and a condenser lens for collecting the almost collimated light flux from the field lens on a sample surface. The distance between the condenser lens and the field lens is variable.

### CROSS REFERENCE TO RELATED APPLICATIONS

This application claims benefit of Japanese Application No. 2007-326009, filed Dec. 18, 2007, the contents of which are incorporated by this reference.

### BACKGROUND OF THE INVENTION

1. Field of the Invention

The present invention relates to a technique of a microscope, and more particularly, to a technique of an illumination apparatus of the microscope.

2. Description of the Related Art

Some microscope users are tall and others are short. Moreover, many users utilize a microscope for many hours, and it is very important for such users to perform microscope operations with an eyepiece unit of a height suitable for their physical sizes.

For conventional microscopes, an optimum height of an eyepiece unit, which varies depending on an individual physical size, is adjusted by inserting an extension tube between an objective lens and a tube lens. The reason why the interval between the objective lens and the tube lens can be extended in this way is that the currently normal microscopes use an objective lens of an infinity corrected type, and a light ray between the objective lens and the tube lens is a collimated light flux.

However, the interval between the objective lens and the tube lens cannot be extended without limitation even if the objective lens is of an infinity corrected type. Especially, an off-axis light ray is emitted from the objective lens at some angle. Therefore, if the distance between the objective lens and the tube lens becomes too long, vignetting can occur or a ray height incident to the tube lens may vary. This affects the image quality.

Accordingly, there is a demand for a method that can change the height of an eyepiece unit by extending/shortening the optics system of a microscope with a method that does not affect the image quality.

### SUMMARY OF THE INVENTION

A microscope illumination apparatus in one aspect of the present invention includes a light source, a collector lens for converting a light ray from the light source into an almost collimated light flux, a field stop provided in the almost collimated light flux from the collector lens, a field lens for converting a light ray from the field stop into an almost collimated light flux, and a condenser lens for collecting the almost collimated light flux from the field lens on a sample surface, wherein a distance between the condenser lens and the field lens is variable.

### BRIEF DESCRIPTION OF THE DRAWINGS

The present invention will be more apparent from the following detailed description when the accompanying drawings are referenced.

FIG. 1A is a schematic diagram exemplifying a method for adjusting the height direction of an eyepiece unit in a conventional upright microscope, and a configuration before being adjusted;

FIG. 1B is a schematic diagram exemplifying the method for adjusting the height direction of the eyepiece unit in the conventional upright microscope, and a configuration after being adjusted;

FIG. 2A is a schematic diagram exemplifying a method for adjusting the height direction of an eyepiece unit in an upright microscope according to an embodiment of the present invention, and a configuration before being adjusted;

FIG. 2B is a schematic diagram exemplifying the method for adjusting the height direction of the eyepiece unit in the upright microscope according to the embodiment of the present invention, and a configuration after being adjusted;

FIG. 3A is a schematic diagram showing a light ray of a Kohler illumination optics system when the light ray is tracked from a field stop;

FIG. 3B is a schematic diagram showing a light ray of the Kohler illumination optics system when the light ray is tracked from a light source;

FIG. 4 is a schematic diagram showing an illumination optics system according to a first embodiment of the present invention;

FIG. 5 is a schematic diagram showing an illumination optics system according to a second embodiment of the present invention;

FIG. 6A is a cross-sectional view of an optics system including a field lens according to the second embodiment in a configuration where an attachment lens 7″ is not used;

FIG. 6B is a cross-sectional view of the optics system including the field lens according to the second embodiment in a configuration where a focal length is extended with an attachment lens 7″;

FIG. 6C is a cross-sectional view of the optics system including the field lens according to the second embodiment in a configuration where the focal length is shortened by using the attachment lens 7″;

FIG. 7 is a schematic diagram showing an illumination optics system according to a third embodiment of the present invention;

FIG. 8A is a cross-sectional view of a field lens with a variable magnification mechanism according to the third embodiment when a focal length is the longest;

FIG. 8B is a cross-sectional view of the field lens with the variable magnification mechanism according to the third embodiment when the focal length is intermediate; and

FIG. 8C is a cross-sectional view of the field lens with the variable magnification mechanism according to the third embodiment when the focal length is the shortest.

### DESCRIPTION OF THE PREFERRED EMBODIMENTS

Embodiments according to the present invention are described below with reference to the drawings.

A method for changing the height of an eyepiece unit in conventional technology is initially described for comparison. With the conventional technology, an objective lens, a stage, a condenser lens, a microscope body, an arm part, etc. are stationary, and only an eyepiece unit moves upward.

The reason why only the eyepiece unit moves is that the current objective lenses are of an infinity corrected type, and a tube lens is positioned within a body tube. Accordingly, the distance between the eyepiece unit and the objective lens has a relatively high degree of arbitrariness.

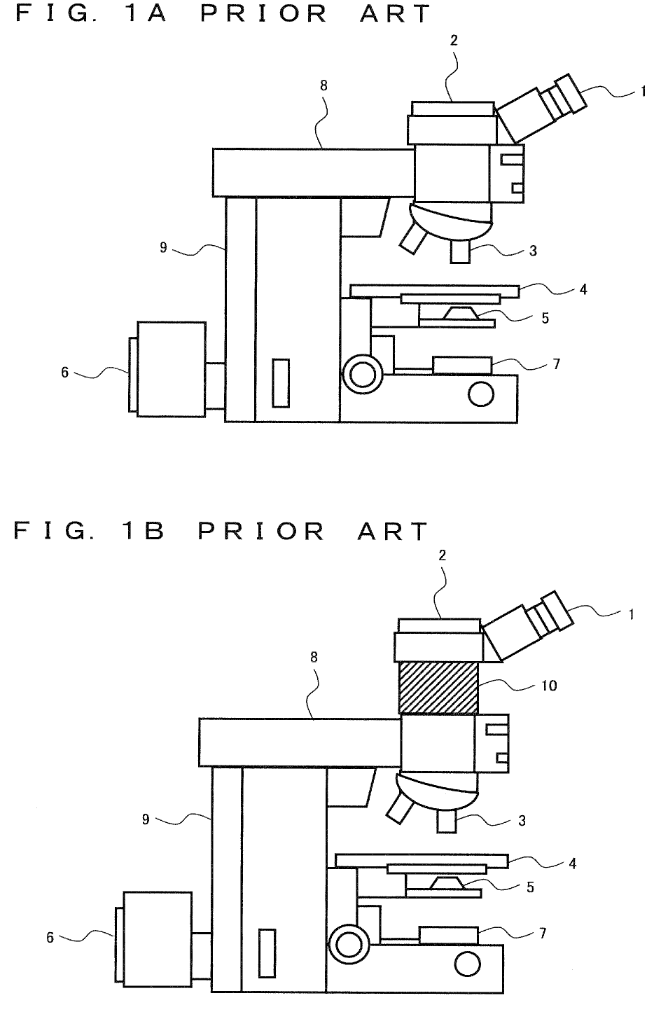

FIGS. 1A and 1B are schematic diagrams exemplifying a method for adjusting the height direction of an eyepiece unit in a conventional upright microscope. A configuration using transmitted illumination is particularly described in this example. A configuration common to the microscopes exemplified in FIGS. 1A and 1B is described first.

A body tube 2 having an eyepiece lens I includes a tube lens, which forms an image of a light ray from an objective lens 3. At this time, a user of the microscope observes the image, which is formed by the tube lens, with the eyepiece lens 1. The objective lens 3 collects transmitted light when a sample on a stage 4 is illuminated with a condenser lens 5. Here, the light ray that illuminates the sample is emitted from a light source within a lamp house 6, and guided to the condenser lens 5 by a field lens 7 via a collector lens not shown. At this time, with Kohler illumination that is a general microscope illumination method, an image of the light source within the lamp house 6 is formed in the front-side focal position of the condenser lens 5 by the collector lens and the field lens 7. Note that the objective lens 3 is secured to a microscope body 9 through an arm part 8. As a result, the height of the objective lens 3 remains unchanged. Since the height of the objective lens 3 remains unchanged, also the heights of the stage 4 and the condenser lens 5 in the periphery of the objective lens 3 remain unchanged fundamentally.

In a conventional microscope, an extension tube 10 is inserted between the body tube 2 and the objective lens 3 in order to change the height of the body tube 2. FIG. 1A shows the configuration of the conventional microscope in its normal state, whereas FIG. 1B shows the configuration of the conventional microscope when the extension tube 10 is inserted. With the conventional method, only the body tube 2 moves upward as shown in FIGS. 1A and 1B.

Meanwhile, in a microscope according to an embodiment of the present invention, not only a body tube but also an objective lens, a stage, a condenser lens, and an arm part altogether move upward and downward. This embodiment particularly adopts a method for inserting an extension unit between an arm part and a microscope body. Also methods such as a method for providing the microscope body with an extension/shortening mechanism can be considered.

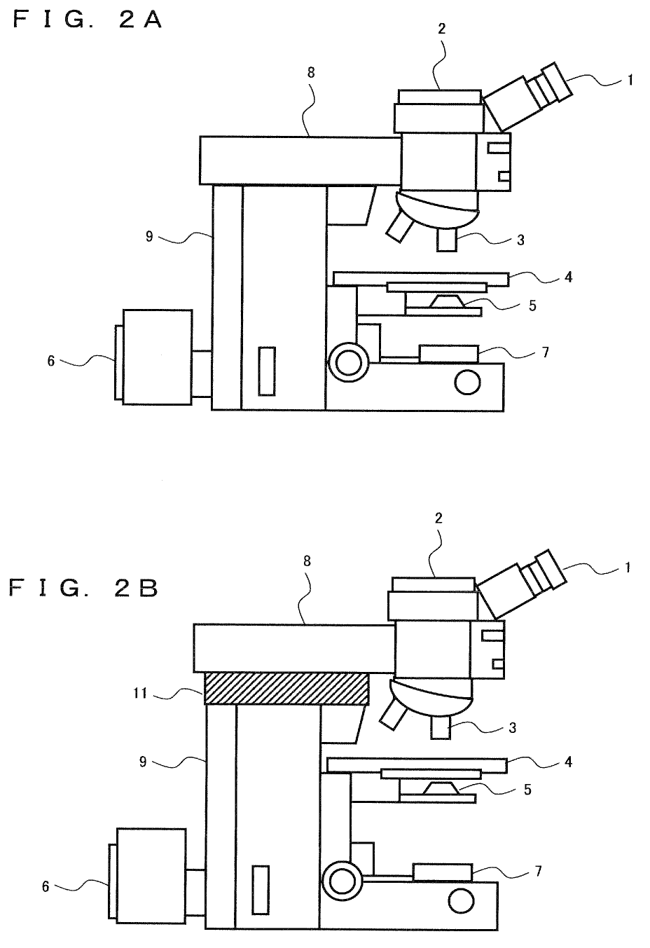

FIGS. 2A and 2B are schematic diagrams exemplifying a method for adjusting an eyepiece unit of an upright microscope according to an embodiment of the present invention. A configuration common to the microscopes shown in FIGS. 2A and 2B is described first.

A body tube 2 having an eyepiece lens 1 includes a tube lens, which forms an image of a light ray from an objective lens 3. At this time, a user of the microscope observes the image, which is formed by the tube lens, with the eyepiece lens 1. The objective lens 3 collects transmitted light when a sample on a stage 4 is illuminated with a condenser lens 5. Here, the light ray that illuminates the sample is emitted from a light source within a lamp house 6, and guided to the condenser lens 5 by a field lens 7 via a collector lens not shown. At this time, with Kohler illumination that is a general microscope illumination method, an image of the light source within the lamp house 6 is formed in the front-side focal position of the condenser lens 5 by the collector lens and the field lens 7.

According to an embodiment of the present invention, a spacer 11 is inserted between an arm part 8 and a microscope body 9 in order to change the height of the body tube 2. FIG. 2A shows the configuration of the microscope according to this embodiment in its normal state, whereas FIG. 2B shows the configuration of the microscope according to this embodiment when the spacer 11 is inserted. In this embodiment, not only the height of the body tube 2 but also that of the objective lens 3 simultaneously changes as shown in FIGS. 2A and 2B.

Also the heights of the stage 4 and the condenser lens 5 alter with the above changes. Note that a normal microscope originally has a function to adjust the heights of the stage 4 and the condenser lens 5. Accordingly, there is no need to add a new constituent element in order to carry out the present invention.

The reason why such changes can be made is that a light ray becomes a collimated light flux between the condenser lens 5 and the field lens 7 when the light ray is tracked from a field stop.

However, it is not desirable to merely change the interval between the condenser lens 5 and the field lens 7 on the ground that the light ray between the condenser lens 5 and the field lens 7 is a collimated light flux. This is because the light ray becomes a converged light flux between the condenser lens 5 and the field lens 7 when the light ray is tracked from the light source. With Kohler illumination, illumination without nonuniformity can be realized by projecting an image of the light source in the front-side focal position of the condenser lens. However, if the distance between the condenser lens and the field lens is changed, the illumination is no longer Kohler illumination.

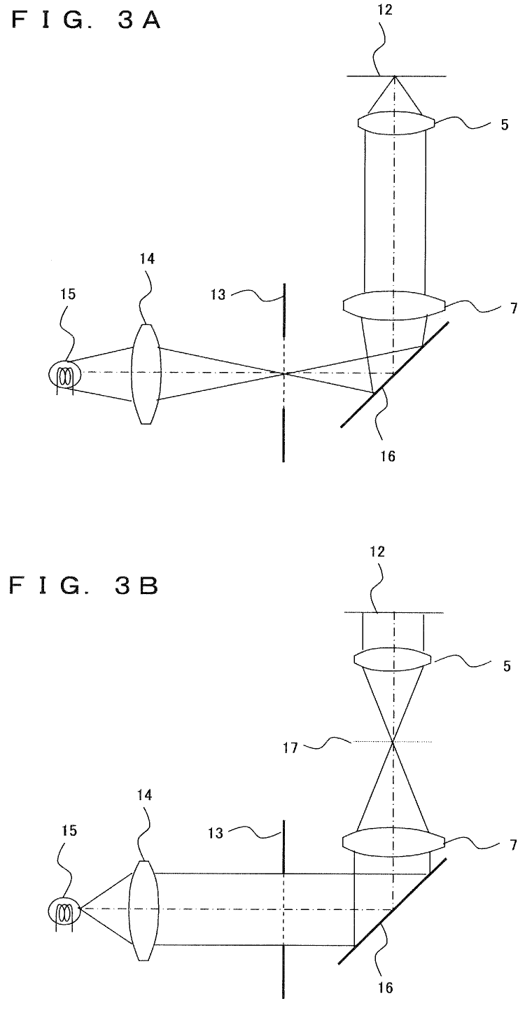

FIGS. 3A and 3B are schematic diagrams showing a light ray of a Kohler illumination optics system. FIG. 3A shows a light ray when being tracked from the field stop, whereas FIG. 3B shows a light ray when being tracked from the light source.

If a light ray is tracked from the field stop as shown in FIG. 3A in reverse to an actual light ray from a sample surface 12 to the light source 15, the light ray started at the sample surface 12 is converted into an almost collimated light flux by the condenser lens 5, and its image is formed on the plane of the field stop 13 by the field lens 7. Thereafter, the light ray reaches the light source 15 via the collector lens 14. General microscopes adopt a configuration where the illumination optics system is bent by a mirror 16 between the field stop 13 and the field lens 7 in order to downsize the microscopes.

When the light ray is tracked from the light source 15 as shown in FIG. 3B, the light ray emitted from the light source 15 is converted into an almost collimated light flux by the collector lens 14, and passes through the field stop 13. Thereafter, the light ray is converted into a converged light flux by the field lens 7, and an image of the light source 15 is formed on a pupil plane 17 of the condenser lens 5. Then, the light ray is converted into a collimated light flux by the condenser lens 5 and illuminated on the sample surface 12 after passing through the pupil plane 17. Since the image of the light source 15 is formed on the pupil plane 17 of the condenser lens 5, illumination with uniformity can be realized on the sample surface 12.

As is proved clearly from a comparison between FIGS. 3A and 3B, the light ray between the condenser lens 5 and the field lens 7 in a Kohler illumination optics system is a collimated light flux when the image of the field stop is tracked (FIG. 3A). However, the light ray is not a collimated light flux when the image on the pupil plane is tracked (FIG. 3B).

This means that the conjugate relationship between the sample surface 12 and the field stop 13 is maintained but the conjugate relationship between the light source 15 and the pupil plane 17 is not maintained if the distance between the condenser lens 5 and the field lens 7 is changed.

Embodiments according to the present invention for solving such a problem are described below.

### First Embodiment

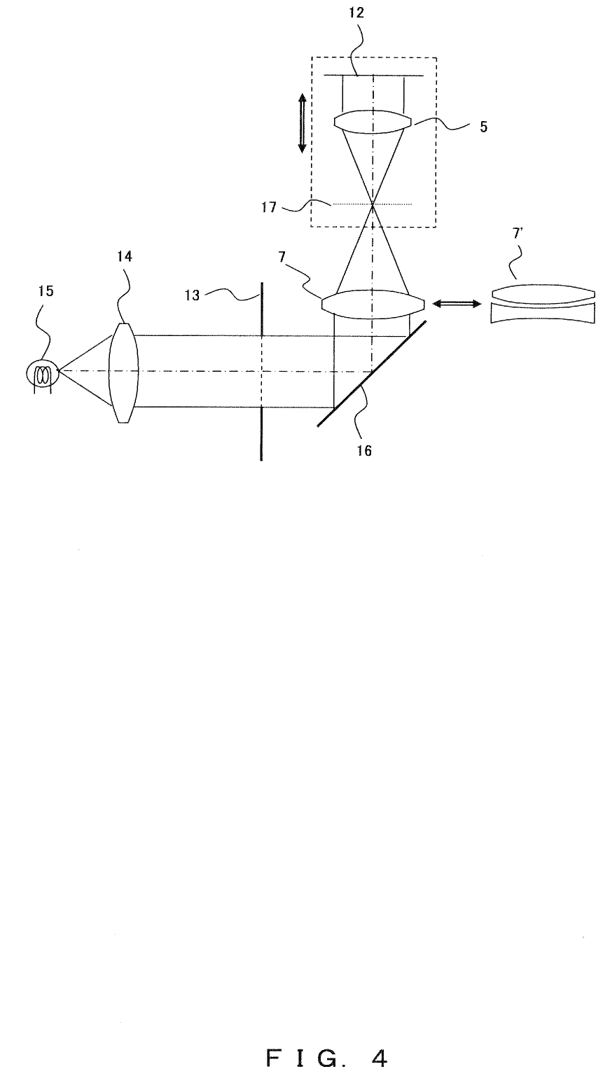

FIG. 4 is a schematic diagram showing an illumination optics system according to a first embodiment of the present invention. In this embodiment, a position conjugate to the light source 15 is changed by replacing the field lens 7 with a field lens 7′ of a different focal length. Moreover, the height of the optics system above the condenser lens 5 can be adjusted while maintaining Kohler illumination by matching the position conjugate to the light source 15 and the pupil plane 17 of the condenser lens. At this time, not the front-side focal position but the focal length of the field lens 7′ used for the replacement is changed. Specifically, a lens type that is configured as a convex lens to a concave lens in this order from the sample side is desirable as the field lens used for the replacement in order to extend the interval between the condenser lens and the field lens. With this lens, the focal length can be extended while maintaining the conjugate relationship between the sample surface 12 and the field stop 13.

### Second Embodiment

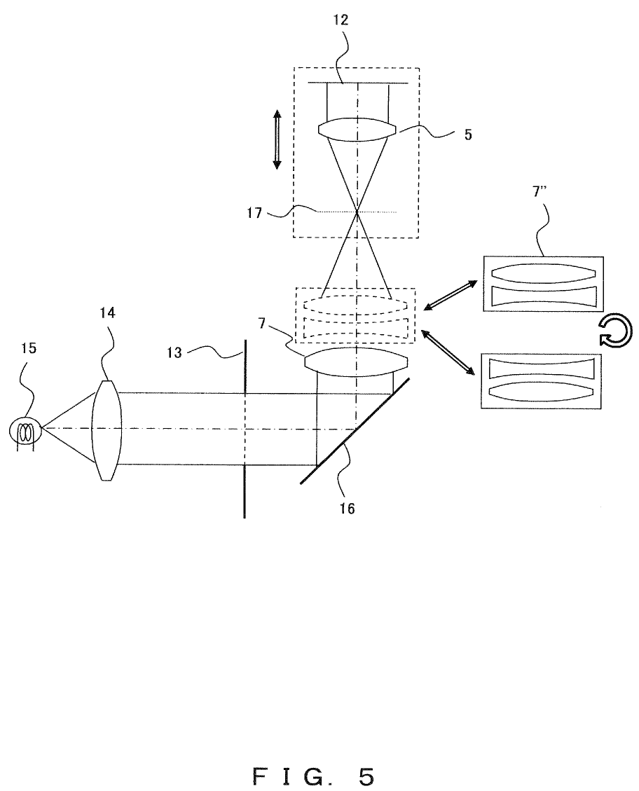

FIG. 5 is a schematic diagram showing an illumination optics system according to a second embodiment of the present invention. In this embodiment, a overall focal length is changed by adding an attachment lens 7″ to the field lens 7. Also in this embodiment, the height of the optics system above the condenser lens 5 can be adjusted while maintaining Kohler illumination by matching the position conjugate to the light source 15 and the pupil plane 17 of the condenser lens 5 in a similar manner as in the first embodiment.

At this time, a configuration where the entire focal length of the field lens 7 is extended or shortened by adding the attachment lens 7″ is considered. For example, by adding the attachment lens 7″ that is configured as a convex lens to a concave lens in this order from the sample side, the entire focal length can be extended. Inversely, by adding the attachment lens 7″ that is configured as a concave lens to a convex lens in this order from the sample side, the entire focal length can be shortened. Moreover, by reversing the top and bottom sides of the attachment lens 7″ that is configured as a convex lens to a concave lens in this order from the sample side, it is available also as the attachment lens 7″ that is configured as a concave lens to a convex lens in this order from the sample side. This lens is desirable because the component can be made common to the cases where the overall focal length is extended and shortened.

Specific configurations of the above described field lens 7 and attachment lens 7″, and examples of lens data are provided below.

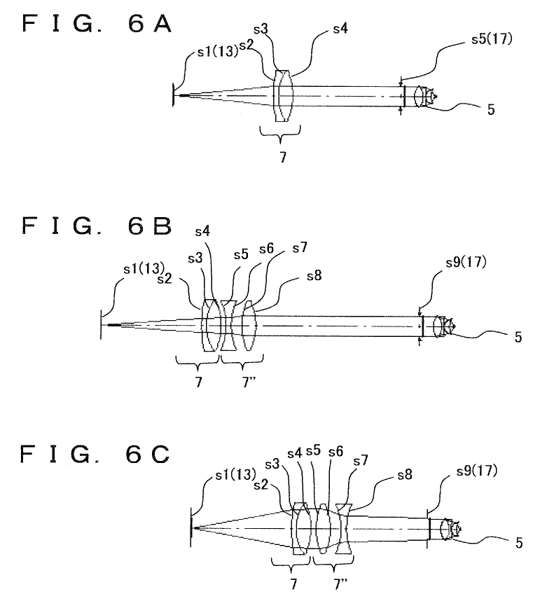

FIGS. 6A, 6B, and 6C are cross-sectional views of the optics system including the field lens according to this embodiment. FIG. 6A shows a configuration where the attachment lens 7″ is not used. FIG. 6B shows a configuration where the focal length is extended by using the attachment lens 7″. FIG. 6C shows a configuration where the focal length is shortened by using the attachment lens 7″. These figures also depict the condenser lens 5 for ease of understanding. However, since the condenser lens 5 is suitably selected and used, its lens data is not provided.

Table 1 is a table that represents the lens data of the configuration using only the field lens 7, which is shown in FIG. 6A. Here, the field stop 13 and the aperture stop (pupil plane 17) are denoted respectively with plane numbers 1 and 5.

TABLE 1
f = 108.05

| Plane | Curvature | Interval | Refractive | Abbe |
|---|---|---|---|---|
| (s) | (r) | (d) | Index (n) | Constant (ν) |
| 1 | infinite | 98.5800 | | |
| 2 | 134.9399 | 4.6000 | 1.67270 | 32.10 |
| 3 | 46.1426 | 14.3750 | 1.51633 | 64.14 |
| 4 | −65.8398 | 108.0500 | | |
| 5 | infinite | | | |

Table 2 is a table that represents the lens data of the configuration where the focal length is extended by adding the attachment lens 7″ to the field lens 7, which is shown in FIG. 6B. Here, the field stop 13 and the aperture stop (pupil plane 17) are denoted respectively with plane numbers 1 and 9. Moreover, data of the plane numbers 5 to 8 are the data of the attachment lens 7″.

TABLE 2
f = 149.02

| Plane | Curvature | Interval | Refractive | Abbe |
|---|---|---|---|---|
| (s) | (r) | (d) | Index (n) | Constant (ν) |
| 1 | infinite | 98.5800 | | |
| 2 | 134.9399 | 4.6000 | 1.67270 | 32.10 |
| 3 | 46.1426 | 14.3750 | 1.51633 | 64.14 |
| 4 | −65.8398 | 5.0000 | | |
| 5 | −60.0000 | 5.0000 | 1.67270 | 32.10 |
| 6 | 60.0000 | 10.3742 | | |
| 7 | 60.0000 | 14.0000 | 1.51633 | 64.14 |
| 8 | −60.0000 | 149.0200 | | |
| 9 | infinite | | | |

Table 3 is a table that represents the lens data of the configuration where the focal length is shortened by adding the attachment lens 7″ to the field lens 7, which is shown in FIG. 6C. Here, the field stop 13 and the aperture stop (pupil plane 17) are denoted respectively with plane numbers 1 and 9. Moreover, data of the plane numbers 5 to 8 are the data of the attachment lens 7″.

TABLE 3
f = 78.3

| Plane | Curvature | Interval | Refractive | Abbe |
|---|---|---|---|---|
| (s) | (r) | (d) | Index (n) | Constant (ν) |
| 1 | infinite | 98.5800 | | |
| 2 | 134.9399 | 4.6000 | 1.67270 | 32.10 |
| 3 | 46.1426 | 14.3750 | 1.51633 | 64.14 |
| 4 | −65.8398 | 5.0000 | | |
| 5 | 60.0000 | 14.0000 | 1.51633 | 64.14 |
| 6 | −60.0000 | 10.3742 | | |
| 7 | −60.0000 | 5.0000 | 1.67270 | 32.10 |
| 8 | 60.0000 | 78.3000 | | |
| 9 | infinite | | | |

As is proved from the lens data represented by Tables 1 to 3, the focal length can be changed in three steps of 78.3 mm, 108.05 mm, and 149.02 mm by inserting/removing the attachment lens 7″ in this embodiment. In addition, the overall focal length is switched to be extended/shortened by reversing the top and bottom sides of the attachment lens 7″ and inserting the lens. Namely, the attachment lens 7″ is inserted between the field lens and the condenser lens so that its top and bottom sides can be reversed. This can make the component common to the cases where the overall focal length is extended and shortened.

Also in this embodiment, the front-side focal position of the field lens 7 remains unchanged. As a result, also the conjugate relationship between the sample surface 12 and the field stop 13 can be maintained.

### Third Embodiment

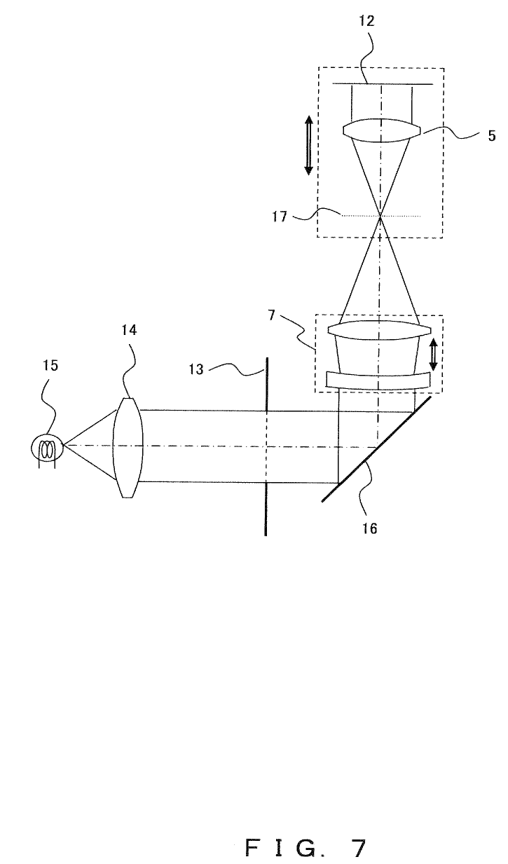

FIG. 7 is a schematic diagram showing an illumination optics system according to a third embodiment of the present invention. In this embodiment, the overall focal length of the field lens 7 is changed by embedding a moving group into the field lens 7, and by moving the moving group. Namely, the field lens 7 is provided with a variable magnification mechanism. Also in this embodiment, the height of the optics system above the condenser lens 5 can be adjusted while maintaining Kohler illumination by matching the position conjugate to the light source 15 and the pupil plane 17 of the condenser lens in a similar manner as in the first and the second embodiments.

Specific configurations of the field lens 7 with the above described variable magnification mechanism, and examples of the lens data are provided below.

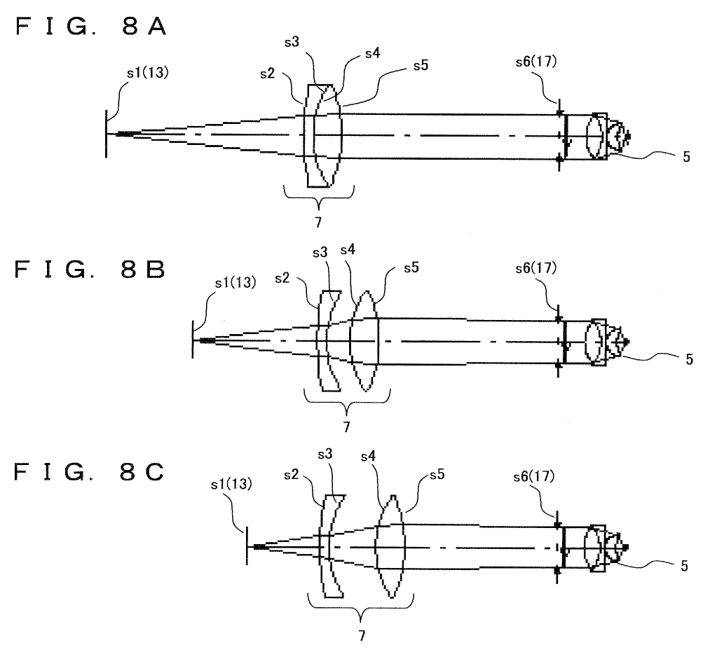

FIGS. 8A, 8B, and 8C are cross-sectional view of the field lens with the variable magnification mechanism according to this embodiment. FIG. 8A shows the state where the focal length is the longest. FIG. 8B shows the state where the focal length is intermediate. FIG. 8C shows the state where the focal length is the shortest. FIGS. 8A to 8C depict also the condenser lens 5 for ease of understanding. However, since the condenser lens 5 is suitably selected and used, its lens data is not provided.

Here, the simplest two-group configuration is cited as an example. However, a three-group configuration, a four-group configuration, etc. can be considered in a similar manner.

Table 4 is a table that represents the lens data when the focal length is made longest with a two-group configuration shown in FIG. 8A. Table 5 is a table that represents the data when the focal length is made intermediate with a two-group configuration shown in FIG. 8B. Table 6 is a table that represents the lens data when the focal length is made shortest with a two-group configuration shown in FIG. 8C. Here, the field stop 13 and the aperture stop (pupil plane 17) are denoted respectively with plane numbers 1 and 6.

TABLE 4
longest f = 109.92

| Plane | Curvature | Interval | Refractive | Abbe |
|---|---|---|---|---|
| (s) | (r) | (d) | Index (n) | Constant (ν) |
| 1 | infinite | 100.2896 | | |
| 2 | 137.2866 | 4.6800 | 1.67270 | 32.10 |
| 3 | 46.9451 | 0.0 | | |
| 4 | 46.9451 | 14.6250 | 1.51633 | 64.14 |
| 5 | −66.9848 | 109.9245 | | |
| 6 | infinite | | | |

TABLE 5
intermediate f = 90.66

| Plane | Curvature | Interval | Refractive | Abbe |
|---|---|---|---|---|
| (s) | (r) | (d) | Index (n) | Constant (ν) |
| 1 | infinite | 100.2896 | | |
| 2 | 137.2866 | 4.6800 | 1.67270 | 32.10 |
| 3 | 46.9451 | 11.7000 | | |
| 4 | 46.9451 | 14.6250 | 1.51633 | 64.14 |
| 5 | −66.9848 | 90.6650 | | |
| 6 | infinite | | | |

TABLE 6
shortest f = 77.15

| Plane | Curvature | Interval | Refractive | Abbe |
|---|---|---|---|---|
| (s) | (r) | (d) | Index (n) | Constant (ν) |
| 1 | infinite | 100.2896 | | |
| 2 | 137.2866 | 4.6800 | 1.67270 | 32.10 |
| 3 | 46.9451 | 23.4000 | | |
| 4 | 46.9451 | 14.6250 | 1.51633 | 64.14 |
| 5 | −66.9848 | 77.1480 | | |
| 6 | infinite | | | |

As is proved from the above provided lens data, the focal length can be changed from 77.15 mm to 109.92 mm in this embodiment.

Note that the variable magnification mechanism of the field lens 7 is configured so that the focal length is changed without altering the front-side focal position. As a result, also the conjugate relationship between the sample surface 12 and the field stop 13 can be maintained. In this embodiment, the focal length of the field lens 7 can be continuously changed, whereby also the height of the eyepiece unit can be continuously changed.

Additionally, the size of an image of the light source in the pupil position of the condenser lens varies depending on the focal length of the field lens. As a result, influences are sometimes exerted on the illumination range of the visual field. Accordingly, it is more effective to arrange an optical element such as a diffuser plate, a fly-eye lens, etc., which reduces illumination nonuniformity, between the light source and the field stop when the focal length of the field lens is changed.

What is claimed is:

1. A microscope illumination apparatus, comprising:
a light source;
a collector lens for converting a light ray from the light source into an almost collimated light flux;
a field stop comprised in the almost collimated light flux from the collector lens;
a field lens for converting a light ray from the field stop into an almost collimated light flux; and
a condenser lens for collecting the almost collimated light flux from the field lens on a sample surface, wherein
a distance between the condenser lens and the field lens is variable.

2. The microscope illumination apparatus according to claim 1, wherein
the field lens includes a focal length changing unit for changing a focal length of the field lens.

3. The microscope illumination apparatus according to claim 2, wherein
the focal length changing unit is a variable magnification mechanism for changing a magnification of the field lens.

4. The microscope illumination apparatus according to claim 3, wherein:
the field lens is configured with two groups composed of a negative lens and a positive lens in this order from a side of the light source; and
the variable magnification mechanism changes the focal length of the field lens by extending an interval between the negative lens and the positive lens.

5. The microscope illumination apparatus according to claim 3, wherein:
the field lens is configured with three groups composed of a first positive lens, a negative lens, and a second positive lens in this order from a side of the light source; and
the variable magnification mechanism changes the focal length of the field lens by extending any of intervals between the first positive lens, the negative lens, and the second positive lens.

6. The microscope illumination apparatus according to claim 2, wherein
the focal length changing unit is an attachment lens added to the field lens.

7. The microscope illumination apparatus according to claim 6, wherein
the attachment lens is configured with two groups composed of a negative lens and a positive lens in this order from a side of the light source, and inserted between the field lens and the condenser lens.

8. The microscope illumination apparatus according to claim 6, wherein
the attachment lens is configured with two groups composed of a positive lens and a negative lens in this order from a side of the tight source, and inserted between the field lens and the condenser lens.

9. The microscope illumination apparatus according to claim 6, wherein
the attachment lens is inserted between the field lens and the condenser lens so that top and bottom sides of the attachment lens can be reversed.

10. The microscope illumination apparatus according to claim 1, wherein
the field lens is replaceable with a field lens for a replacement, which has a focal length different from the field lens.

11. The microscope illumination apparatus according to claim 10, wherein
the field lens for the replacement is configured with two groups composed of a negative lens and a positive lens in this order from a side of the light source.

12. The microscope illumination apparatus according to claim 2, wherein
the focal length of the field lens is changed while a front-side focal position of the field lens is being fixed to a position of the field stop.

13. The microscope illumination apparatus according to claim 12, wherein:
a position of the field stop and the sample surface are conjugate; and
the light source and the front-side focal position of the condenser lens are conjugate.
